(19) United States
(12) Patent Application Publication
(10) Pub. No.: US 2004/0047234 A1
(43) Pub. Date: Mar. 11, 2004

(54) Method of monitoring a drilling path

(76) Inventors: Philip Armstrong, Houston, TX (US); Ahmed Shabbir, Islamabad (PK); Masahiro Kamata, Kawasaki-shi (JP)

Correspondence Address: Intellectual Property Law, Schlumberger K K, 2-1-1 Fuchinobe Sagamihara-shi, Kanagawa-ken, 229-0006, JP

(21) Appl. No.: 10/450,025

(22) PCT Filed: Oct. 19, 2001
(86) PCT No.: PCT/IB01/01968

(51) Int. Cl. H04H 9/00

(52) U.S. Cl. 367/81

(57) ABSTRACT

A method of monitoring the path of a borehole comprises acquiring drill bit seismic data while a borehole is being drilled. The acquired drill bit seismic data is used to determine whether the drilling path of the borehole is correct, for example by using the acquiring drill bit seismic data to update the geological model used to determine the drilling path. The drilling path of the borehole is updated using seismic data acquired as the borehole is being drilled, so that it is not necessary to interrupt the drilling process in order to update the drilling path. The invention thus makes possible a real-time, or near real-time, method of progressively updating the drilling path. The invention also provides a method of determining the properties of a surface or near-surface layer (7). The source of seismic energy for this method is acoustic energy, generated by the impact of the drill bit (9), that is transmitted up the drill string (10) and re-radiated into the earth at the top of the borehole (6).

The present invention relates to a method of monitoring the path of a borehole, in particular to a method that enables the path of the borehole to be monitored while drilling of the borehole is in progress. The invention also relates to a method of seismic surveying, in particular to a method of reverse VSP seismic surveying that provides information on the properties of a surface or near-surface layer of the earth.

Seismic data are collected using an array of seismic sources and seismic receivers. The data may be collected on land using, for example, explosive charges as sources and geophones as receivers, or the data may be collected at sea using, for example, airguns as the sources and hydrophones as the receivers.

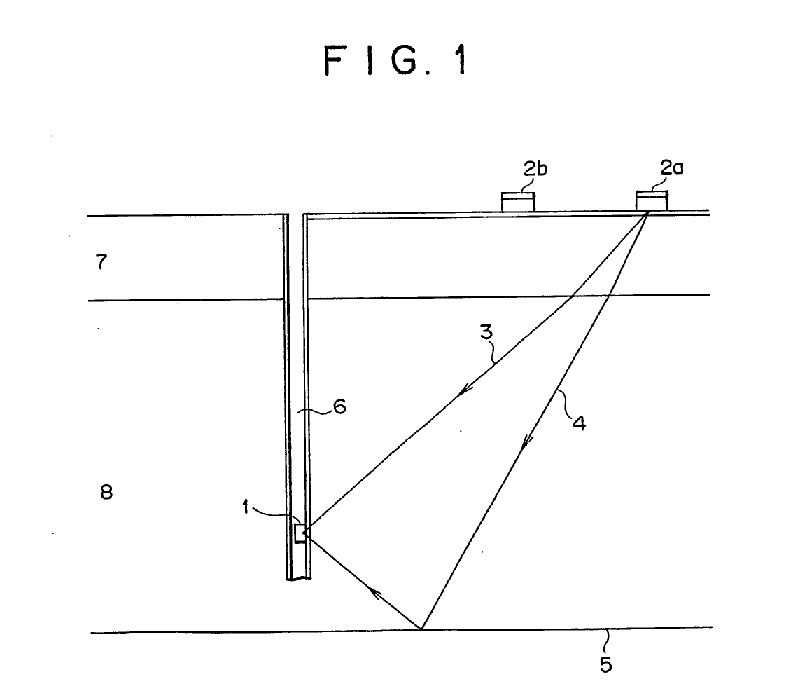

FIG. 1 is a schematic illustration of the survey geometry for the method of seismic surveying known as vertical seismic profiling (VSP) surveying. In this surveying geometry, the receiver 1 is not disposed on the earth's surface, but is disposed within the earth, in this example within a borehole 6. One or more seismic sources 2a, 2b are disposed on the earth's surface. Two ray paths for seismic energy are shown in FIG. 1. Path 3 is a path in which the seismic energy does not undergo reflection, although it is refracted at the boundary between two layers 7, 8 of the earth. Since seismic energy that travels along this path travels direct from the source 2a to the receiver 1 without reflection, this path is known as the “direct path”. Path 4 is a path in which seismic energy emitted by the source 2a is incident on the receiver 1 after reflection by a reflector 5 located at a greater depth than the receiver, and is thus known as a “reflection path”.

In FIG. 1 the seismic sources 2a, 2b are located at a distance from the point at which the vertical line on which the receiver 1 is disposed passes through the earth's surface. This geometry is known as offset VSP, since there is a non-zero horizontal distance between the seismic source and the receiver. The horizontal distance between the seismic source and the receiver is generally known as “offset”.

FIG. 1 shows the survey geometry known as multi-offset VSP, in which a plurality of seismic sources are located on the surface of the earth, with each source having a different offset (i.e., being at a different horizontal distance from the point at which the vertical line on which the receiver 1 is disposed passes through the earth's surface). In an alternative VSP geometry, a single seismic source is used, and this may be located vertically over the receiver (“zero-offset VSP”) or at a fixed offset from the receiver.

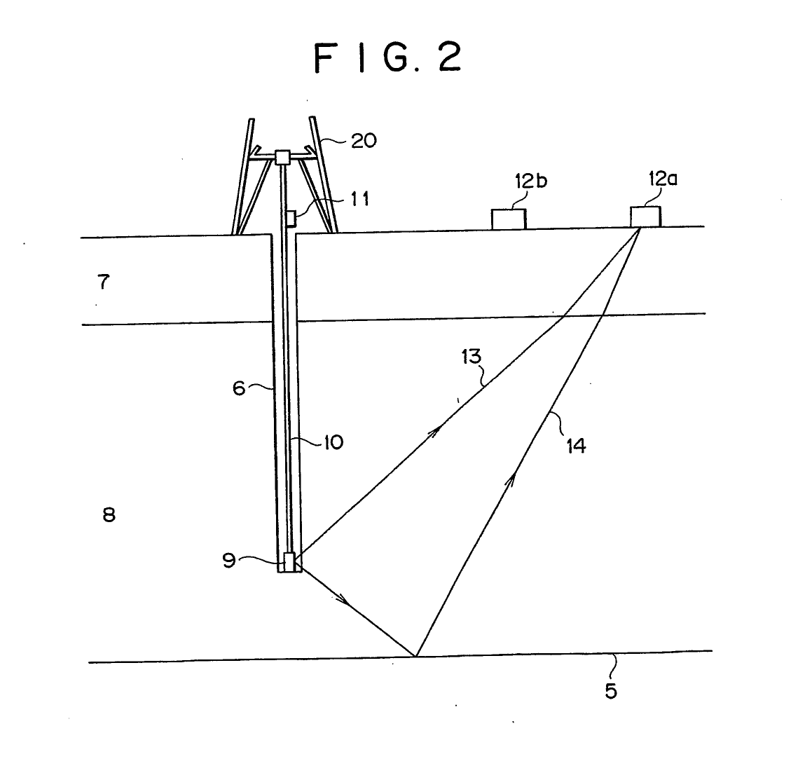

One application of VSP seismic surveying is in “look-ahead” surveying. This form of seismic surveying is used during the drilling of a borehole. One or more seismic receivers are placed in the borehole, above the drilling head, and are used to gather information about the geological structure beneath the drilling head. This is possible because, as shown in FIG. 2, seismic energy that follows the reflection path 14 provides information about the reflector 5, which is at a greater depth than the seismic receiver 9. Decisions concerning the drilling operation, for example determining the safe distance to drill before setting the next string of casing, are made on the basis of information gathered about the underlying geological structure.

Conventional VSP seismic surveying has the disadvantage that it is relatively expensive to carry out. It can be difficult to set up the survey arrangement, since significant amount of vegetation may need to be cleared in order to allow the seismic sources to be located in the desired positions. Personnel are required to operate the receivers in the borehole and the seismic sources and, moreover, the drilling process must be interrupted for a significant interval to allow the acquisition of seismic data.

An alternative form of VSP seismic surveying is “reverse VSP” surveying. In reverse VSP seismic surveying one or more seismic source are disposed within a borehole, and an array of seismic receivers are disposed on the earth's surface. The paths of seismic energy in reverse VSP surveying are the same as those illustrated for the VSP surveying arrangement of FIG. 1, except that the direction of travel of seismic energy is reversed.

In one type of reverse VSP surveying a drill bit disposed within a borehole is used as the energy source for a seismic survey. This technique is known as drill bit seismic VSP or DBS VSP, and is described in, for example, U.S. Pat. No. 5,144,589. The impact of the drill bit with the earth's interior during drilling generates noise, and in DBS VSP surveying the noise generated by the drill bit is used as a source of seismic energy. One or more seismic receivers are disposed on the earth's surface, and these detect seismic energy from the drill bit.

Conventional seismic sources are impulsive sources, and generate a pulse of seismic energy having a short duration. It is therefore straightforward to determine the time delay between emission of seismic energy by a seismic source and the arrival of the seismic energy at a receiver. In contrast, a drill bit acts as a continuous source of seismic energy, so that it is less straightforward to determine the travel time of seismic energy from the drill bit to the receiver in seismic data obtained in a DBS VSP survey.

One technique used in DBS VSP surveying is to dispose a sensor, such as an accelerometer, on the drill string near the earth's surface. Seismic data acquired by a receiver are correlated with the signal measured by the accelerometer. The correlated data may be further processed, for example using a deconvolution technique such as that described in U.S. Pat. No. 5,148,407 or by Haldorsen et al in “Geophysics”, Vol. 60, No. 4, pp 978-997 (1995).

The general arrangement of a drill bit seismic VSP seismic surveying arrangement is shown in FIG. 2. A drill bit 9 attached to a drill string 10 is disposed within a borehole 6. The drill string is supported by a support rig shown schematically as 20. Reference 11 denotes an accelerometer disposed on the drill string 10 at the earth's surface, for detecting seismic energy that has been transmitted from the drill bit 9 along the drill string 10. An array of seismic receivers (two receivers 12a, 12b are shown in FIG. 2) receive acoustic energy emitted by the drill bit 9. The seismic receivers are connected to suitable data storage apparatus and/or data processing apparatus (not shown).

The seismic energy may travel from the drill bit 9 to one of the receivers either by a direct path 13 or by a reflection path 14. It will be seen that the seismic energy paths 13, 14 of the DBS VSP surveying arrangement of FIG. 2 are geometrically similar to the seismic energy paths 3, 4 in the offset-VSP surveying arrangement of FIG. 1—both direct paths and reflection paths exist in DBS VSP surveying. However, seismic energy travels in the reverse direction along the paths 13, 14 of FIG. 2 compared to the paths 3, 4 of FIG. 1.

The receivers in a DBS VSP survey arrangement are generally disposed in groups that extend radially from the borehole at one or more selected azimuths. Each radially-extending group of geophones may have a length of 1 kilometre or more. One example of a suitable seismic receiver for a DBS VSP survey is a geophone.

Drill bit seismic VSP has the advantage, compared to conventional VSP, that it is carried out while drilling is in process, and does not require drilling to be stopped. Performing seismic surveying while a drilling operation is in process is sometimes known as “seismic while drilling” or SWD. Further advantages of DBS VSP surveying, and indeed of reverse VSP surveying in general, are that it does not require much land clearance and that, once set up, it can be operated remotely with minimal operator intervention.

One problem involved in drilling a borehole is that of ensuring that the borehole reaches a target geological structure that it is desired to hit, such as a potential oil reservoir, or avoids a target geological structure that it is desired to miss. A drilling path for the borehole is prepared before starting to drill, and this is based on pre-existing knowledge of the geological properties of the earth's interior in the vicinity of the survey location. The geological properties of the earth's interior will not be known exactly, however, so that there is a risk that drilling path for the borehole will be incorrect and the borehole will not reach a target geological structure that it is desired to hit (or avoid a target geological structure that it is desired to miss).

U.S. Pat. No. 5,995,446 discloses the use of VSP seismic surveying to update a geological model during a drilling operation. An initial geological model of the drilling zone is developed, and is used to plan the initial course of the borehole. After the borehole has been drilled to a predetermined depth drilling is halted, and a VSP survey is carried out using a seismic receiver disposed within the borehole. The results of the VSP survey are used to update the geological model and, if necessary, the planned course of the borehole is altered. Drilling is then re-started.

A first aspect of the present invention provides a method of monitoring the path of a borehole, the method comprising the steps of: drilling a borehole along a first path; acquiring drill bit seismic data; and determining from the acquired drill bit seismic data whether the first path is correct.

According to this aspect of the invention, drill bit seismic data such as DBS VSP data is used to update the path of the borehole, for example by updating the geological model of the earth's interior that was used to determine the path of the borehole. The drill bit seismic data is acquired as the borehole is drilled, so that the path of the borehole can be monitored without halting the drilling operation. In contrast, the method of U.S. Pat. No. 5,995,446 requires that drilling operation is interrupted to allow the VSP survey to be performed.

Moreover, it is possible to acquire DBS VSP continuously during the drilling operation, and this makes it possible to update the geological model in real-time, or near real time, during the drilling operation.

As the drill bit goes deeper into the earth's interior during a drilling operation, DBS VSP data acquired using a direct path becomes available at greater depths. Thus, initially only reflection data is available for a given depth within the earth but, once the drill bit reaches that depth, DBS VSP data acquired using a direct path also becomes available for that depth. This new information obtained from direct path DBS VSP data is used to update the initial geological model derived from the data and, if necessary, the course of the borehole is modified as a result of updating the geological model to ensure that the borehole is directed into—or away from—a chosen region of the earth's interior.

A second aspect of the present invention provides a method of seismic surveying comprising the steps of: disposing a drill string including a drill bit in a borehole; and detecting seismic energy from the drill bit after transmission through the drill string and emission from the drill string at or near the earth's surface at a first seismic receiver disposed at or near the earth's surface.

One problem encountered in seismic surveying is that the seismic properties of the earth near the earth's surface are generally very different from the seismic properties of the earth's interior. In general, the velocity of seismic energy in a layer 7 at or near the earth's surface is lower than the velocity of seismic energy in deeper layers, and the surface or near-surface layer 7 is generally known as a low velocity layer or “LVL”. The LVL is affected by weathering of the earth's surface, so that its depth may have significant variations. The LVL 7 is shown at the earth's surface in FIGS. 1 and 2, but it need not extend to the earth's surface and there could be one or more layers overlying the LVL 7.

In a VSP survey the seismic sources (in conventional VSP surveying) or seismic receivers (in reverse VSP) are disposed at or near the earth's surface, so that the seismic energy must pass through the LVL 7. Since the seismic properties of the LVL 7 are atypical of the properties of the earth's interior, the acquired seismic data are affected by the LVL 7. It is necessary to carry out a separate seismic survey to determine the properties of the LVL 7, in order to correct the acquired seismic data for the effects of the LVL 7. This is known as correcting for source and/or receiver statics. The need to make these corrections increases the cost and complexity of the VSP survey.

In drill bit seismic VSP, not all acoustic energy generated by the drill bit is radiated into the part of the earth's interior that surrounds the borehole. Some of the acoustic energy is transmitted upwards from the drill bit along the drill string on which the drill bit is mounted, and some of this upwardly transmitted energy will be re-radiated into the earth's interior via the support means for the drill string and will be detected by the receivers of the DBS VSP surveying arrangement thereby obscuring the seismic data acquired at the receivers. Since acoustic energy transmitted from the drill string into the earth tend to obscure the seismic data, it has hitherto been considered to be undesirable. Considerable effort has been put into minimising the amount of seismic energy re-radiated in this way, and also into techniques for processing out the effects on the acquired seismic data of energy re-radiated into the earth.

The second aspect of the present invention, in contrast, sets out to utilise energy that is transmitted upwards along the drill string and re-radiated into the earth. In particular, the invention uses this re-radiated acoustic energy as a source of “secondary” seismic energy within the LVL. Energy re-radiated into the earth near the earth's surface will propagate through the LVL.

If receivers for a reverse VSP surveying arrangement are deployed around the borehole, the receivers will receive the energy re-radiated into the earth (in addition to energy received along the usual reverse VSP paths), and this can be processed to obtain information about the seismic properties of the LVL layer. This information about the seismic properties of the LVL layer can be used, in turn, to correct seismic data for the effects of the LVL. The need for a separate LVL survey is thus eliminated.

Information about the properties of the LVL 7 obtained using a method of the second aspect of the invention can be applied to a monitoring method according to the first aspect of the invention. The drill bit seismic data acquired while drilling the borehole can be corrected for the effects of the LVL, using information about the properties of the LVL 7 obtained from the energy transmitted upwards along the drill string and re-radiated into the earth at the top of the drill string.

A typical reverse VSP receiver array may extend for over a kilometre from the borehole. The intensity of energy re-radiated into the earth at the top of the borehole after transmission up the drill string is low, so that a measurable signal may be recorded only at receivers close to the borehole. In a preferred embodiment of the invention therefore, a method according to the first aspect of the invention further comprises actuating a seismic source disposed at or near the earth's surface, and receiving seismic energy emitted by the seismic source at the seismic receivers. This makes it possible to obtain additional information about the LVL. Although an additional seismic source is used, it is not necessary to provide any additional receivers since the receivers of the reverse VSP surveying arrangement can be used to obtain the LVL data.

Other preferred features of the present invention are set out in the dependent claims.

Preferred embodiment of the present invention will now be described by way of illustrative example with reference to the accompanying Figures in which:

FIG. 1 is a schematic view of a conventional offset VSP seismic survey arrangement;

FIG. 2 is a schematic view of a conventional reverse VSP seismic survey arrangement;

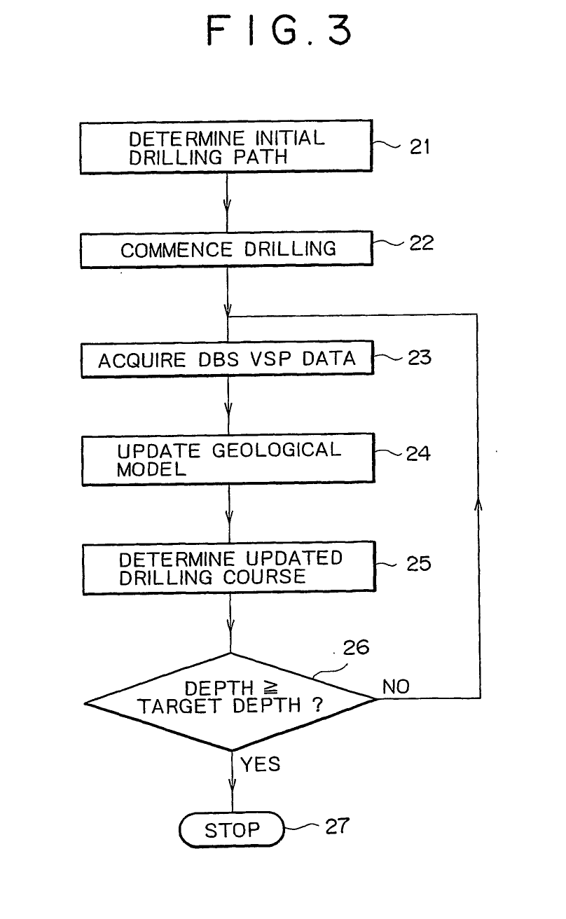

FIG. 3 is a flow chart illustrating a first embodiment of the present invention;

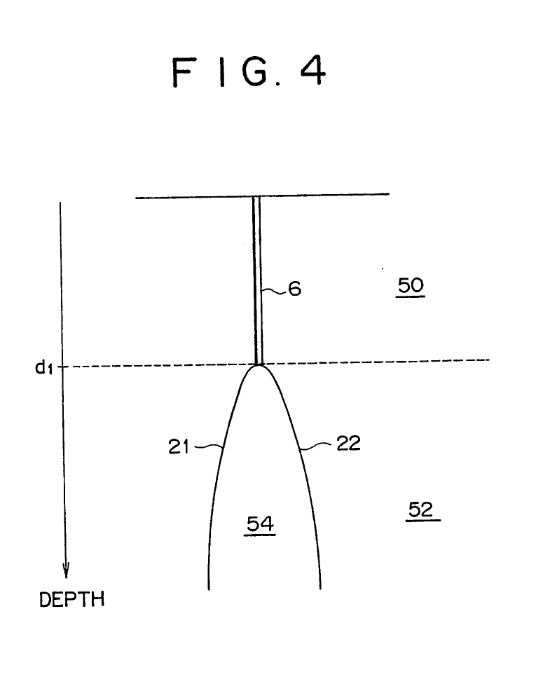

FIG. 4 is a schematic view illustrating the first embodiment of the invention;

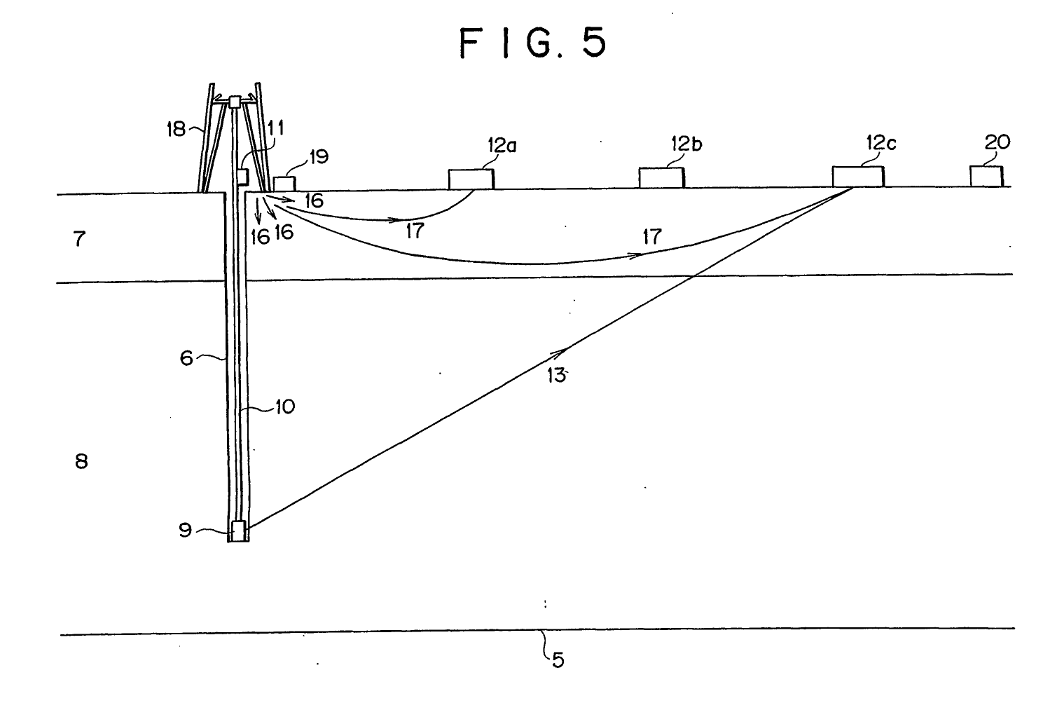

FIG. 5 is a schematic view of a drill bit seismic VSP seismic survey arrangement illustrating another embodiment of the present invention; and

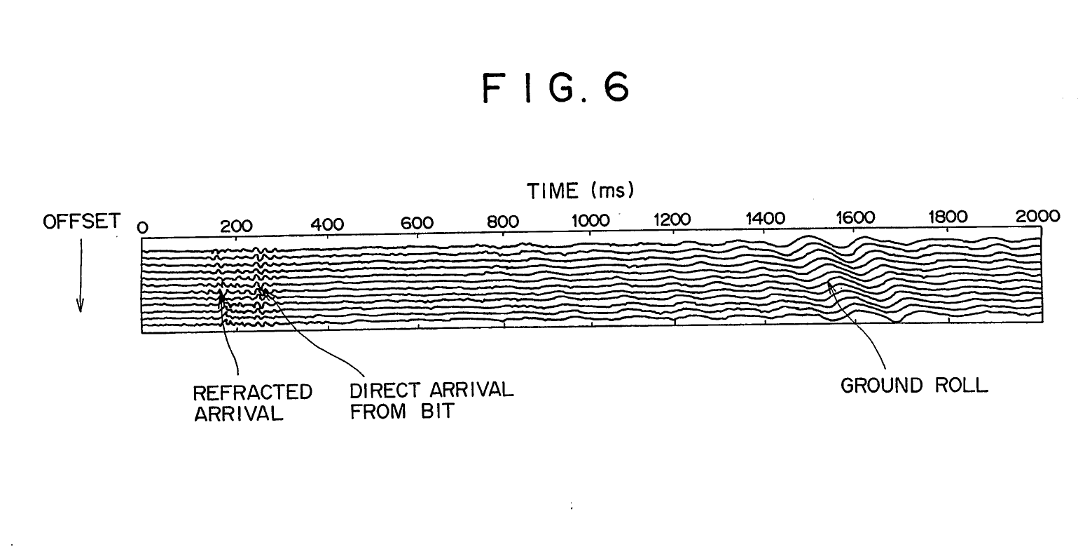

FIG. 6 shows seismic data acquired by the VSP seismic survey arrangement of FIG. 5.

Like reference numerals refer to like components throughout the Figures.

A first embodiment of the present invention provides a method of monitoring the path of a borehole that enables the geological model used to determine the course of the borehole to be updated while drilling the borehole, so eliminating the need to halt the drilling operation. This embodiment of the invention can be carried out using a conventional drill string and a conventional drill bit seismic VSP surveying arrangement, such as, for example a DBS VSP surveying arrangement generally as shown in FIG. 2.

The principal steps of a method according to this embodiment of the invention are shown in FIG. 3.

At step 21 an initial course is determined for a borehole that is desired to reach a target zone within the earth's interior, possibly while also avoiding one or more regions of the earth's interior. The initial course may be determined from, for example, an initial geological model of the part of the earth's interior that surrounds the target zone of the drilling operation. The initial geological model may be determined from pre-existing seismic data acquired at the survey location or from pre-existing geological knowledge of the earth's interior at the survey location. The initial geological model may alternatively be determined by collecting preliminary seismic data at the survey location. Such data may be obtained for example by drilling the borehole to an initial depth and then performing a conventional VSP or a reverse VSP seismic survey. In this case, information about the geological structure of the earth's interior below the initial depth of the borehole can be derived from reflection paths such as path 4 in FIG. 1 or path 14 in FIG. 2.

At step 22 the drilling operation along the initial path is started, and at step 23 the acquisition of drill bit seismic VSP data is started.

FIG. 4 is a schematic view of the drilling operation at a point where the borehole has reached a depth d₁, which is assumed to be less than the target depth of the borehole. For depths that are shallower than d₁, 50, DBS VSP data acquired using a direct path are available, and DBS VSP data acquired using a reflection path are also available. For depths that are deeper than d₁, 52, only DBS VSP data acquired using a reflection path are available. However, there is a region 54 of the earth's interior located below the borehole for which no DBS VSP data are available. The width of this region for which no DBS VSP data are available is determined by the offset between the borehole and the nearest receiver 2b, and increases with increasing depth below the depth d₁. There is also a second region for which no DBS VSP data are available, and this region starts at a radial distance from the borehole which is determined by the offset between the borehole and the most distant receiver 2a, and increases with increasing depth below the depth d₁. Thus, as shown in FIG. 4, the zone in which reflection DBS VSP data are available is contained between two boundaries 21, 22. One boundary 21 is defined by the locus of the reflection point for rays that are reflected to the nearest receiver 2b, and the other boundary 22 is defined by the locus of the reflection point for rays that are reflected to the most distant receiver 2a. The shape of the zone in which reflection DBS VSP data are available varies with the depth at which the data are acquired.

As the drill bit goes deeper into the earth's interior during the drilling operation, DBS VSP data acquired using a direct path become available at greater depths; once the drill bit reaches a given depth, DBS VSP data acquired using a direct path become available for that depth. In the present invention, the path of the drill to the target zone is progressively updated as the borehole is made deeper and DBS VSP data become available at greater depths.

In the embodiment of FIG. 3 the progressive updating of the path of the drill is carried out by progressively updating the geological model of the earth's interior around the target zone. The planned course of the borehole is updated if the updated geological model shows this to be necessary.

Thus, at step 24, the initial geological model is updated using the DBS VSP data, and in particular using direct path DBS VSP data that have become available for depths down to the current depth of the drill-bit. At step 25 the planned course of the borehole is modified if necessary, dependent on the results of updating the geological model at step 24.

At step 26 it is determined whether the borehole has reached the target depth. If the determination shows that the target depth has not been reached, steps 23, 24, 25 and 26 are repeated, and this process is continued until a “Yes” determination is obtained at step 26, whereupon the drilling operation is stopped at step 27.

The present invention thus provides a method that allows the geological model to be progressively updated as the drilling operation is in progress. Since the geological model is updated using seismic data acquired using the drill bit noise as the seismic energy source, the updating process does not require the drilling operation to be halted, in contrast to the method of U.S. Pat. No. 5,995,446.

In principle, steps 24 and 25 can be carried out in real-time. However this would require considerable processing power and may currently not be commercially attractive. In a preferred embodiment of the invention, therefore, the updating of the geological model is carried out in near real-time, to reduce the processing power required.

In this preferred embodiment, DBS VSP data acquired during a time period from t₁ to t₂, during which the depth of the borehole increases from d₁ to d₂ are recorded and stored. During the time period from t₂ to t₃, the borehole is drilled along the current path, from depth d₂ to depth d₃. During the time period from t₂ to t₃ the geological model is also updated using the data acquired during the time period t₁ to t₂, and a determination is made as to whether the course of the borehole should be changed. If a change in the course of the borehole is necessary, the change is made at time t₃ and drilling at times after t₃ is carried out along the updated course.

This process is then repeated as necessary: DBS VSP data acquired during a subsequent time period are recorded and stored, and the geological model is updated on the basis of these data during a yet later time period. Thus there is a slight delay between acquiring DBS VSP seismic data and updating the geological model and this embodiment can be thought of as providing near real-time updating, or “relevant time” updating, of the geological model.

For example, the acquisition period might typically extend over approximately 200 m of drilling. It could take from a few hours to several days to drill this depth, depending on the properties of the formation being drilled. It will usually be sufficient if the newly acquired data can be processed so that results, from which decisions concerning the drilling path can be made, are available within approximately 24 hours of the acquisition being completed. This timescale may be regarded as “relevant time” (that is, soon enough that decisions can be made based on the processed data).

The above method of monitoring the path of a borehole may be carried out using a conventional DBS VSP surveying arrangement, for example a DBS VSP surveying arrangement similar in principle to the surveying arrangement shown in FIG. 2. A suitable receiver array for a land-based survey is a linear radial geophone array, extending at one or more selected azimuths from the borehole. In the case of a marine-based survey, such as a sea-bed survey, a dual sensor array is a suitable receiver array.

A further aspect of the invention addresses the problem of correcting the acquired DBS VSP seismic data for the effects of the LVL. This embodiment will be described with reference to FIGS. 5 and 6.

FIG. 5 illustrates a DBS VSP surveying arrangement suitable for carrying out this aspect of the invention. It is generally similar to the conventional surveying arrangement of FIG. 2, and comprises a drill bit 9 attached to a drill string 10 within a borehole 6. Means for supporting and driving the drill string 10 are provided at the earth's surface, and are indicated schematically by 18. A sensor 11, such as an accelerometer, is disposed on the drill string 10 near the earth's surface, for detecting seismic energy that has been transmitted from the drill bit 9 along the drill string 10.

According to the present invention, acoustic energy that is generated by the impact between the drill bit 9 and the earth's interior and that propagates upwards along the drill string 10 is used as a source of seismic energy for a survey of the LVL layer 7. The support member 18 provides acoustic coupling between the drill string 10 and the earth, so that some of the acoustic energy propagating up the drill string 10 will be transmitted through the support member 18. This energy will be re-radiated into the earth's interior as indicated by the arrows 16 thereby creating a secondary source of seismic energy within the LVL.

Acoustic energy re-radiated into the earth's interior in this way is detected by the seismic receivers of the DBS VSP receiver array which are disposed on the earth's surface. Three seismic receivers 12a, 12b, 12c are shown in FIG. 5, but in practice a large number of seismic receivers, such as geophones, will be provided. The receivers are preferably arranged in a regular array, for example in groups that extend radially from the borehole. The seismic receivers are connected to suitable data storage apparatus and/or data processing apparatus (not shown).

Only a direct path 13 of seismic energy between the drill bit 9 and the receiver 12c is shown in FIG. 5, but reflection paths will also exist.

Possible paths 17 of the secondary seismic energy radiated into the LVL are shown in FIG. 5. The secondary seismic energy initially propagates in a downwards direction, but undergoes refraction within the LVL as a consequence of variations of the velocity of seismic energy with depth within the LVL. The seismic energy is refracted upwards, and is incident on one of the seismic receivers 12a, 12b, 12c.

The paths 17 of seismic energy do not involve reflection at the interface between the LVL 7 and the layer 8. The seismic energy path 17 is wholly within the LVL 7, and is determined only by refraction within the LVL 7. The time taken for seismic energy to traverse the path 17 is thus determined solely by the properties of the LVL layer 7, and it is possible to obtain information on the properties of the LVL from the travel time of seismic energy along the path 17.

The sensor 11 mounted on the drill string 10, near the earth's surface, detects acoustic energy that is transmitted from the drill bit up the drill string 10. The output from the sensor 11 is used to correlate the data acquired by the receiver 12, in a conventional manner for processing reverse VSP seismic data.

FIG. 6 shows results obtained using a reverse VSP surveying arrangement of the present invention. FIG. 6 shows the seismic traces recorded at 12 seismic receivers, as a function of time, after correlation with the signal from the sensor 11 mounted on the drill string. Each receiver had a different offset, and the traces are arranged in order of increasing offset.

The first event in each trace in FIG. 6 is the arrival of the secondary seismic energy—that is, the arrival of seismic energy that is transmitted up the drill string 10, passes into the earth's interior near the earth's surface, and follows a path, such as path 17, in the LVL 7 to the receiver. This is labelled as the “refracted arrival” in FIG. 6.

The second event in each trace in FIG. 6 is the direct arrival of seismic energy that was radiated directly into the earth's interior from the drill bit and that follows a direct path 13 to the receiver. This is labelled as “direct arrival from bit” in FIG. 6. It will be seen that the moveout (variation with offset) of the arrival time of the refracted arrival is greater than the moveout of the arrival time of the direct arrival.

The feature in the seismic traces at 1400-1600 ms is ground roll noise.

To determine the travel time of seismic energy in the LVL 7 along the path 17, the time taken for acoustic energy to travel up the drill string 10 must be subtracted from the arrival time recorded by the receiver 12. This can be done, for example, by disposing a further seismic receiver 19 adjacent to the top of the borehole 6, so that the offset between the borehole and the adjacent seismic receiver 19 is minimal. The receiver 19 adjacent to the borehole can be used this as a reference receiver to determine the travel time of seismic energy up the drill string 10. The use of such a reference receiver allows the arrival times of the refracted arrival in the seismic data to be interpreted in a similar way to a conventional LVL survey.

It can accordingly be seen that this aspect of the present invention eliminates the need to carry out a separate LVL survey. By using the acoustic energy transmitted up the drill string as a source of seismic energy in the LVL, it is possible to estimate the velocity of the seismic energy in the LVL and the depth of the LVL from the refraction arrival event in the reverse VSP data. This information can be used to correct for the effects of the LVL 7 on the direct arrival event in the reverse VSP data.

A DBS VSP receiver array may extend for over 1 km from the borehole. The intensity of the secondary acoustic energy received at a receiver will generally decrease rapidly as the offset of the receiver increases, so that the secondary acoustic energy signal recorded by a receiver that is a long way from the borehole may be so small that its arrival time cannot be determined accurately. In this event, it will be possible to obtain reliable information about the properties of the LVL only for the part of the LVL close to the borehole. This may be sufficient if the properties of the LVL are substantially uniform over the survey area, but in some cases the thickness and properties of the LVL can vary significantly over a survey area. In a preferred embodiment of the invention, therefore, a further source of seismic energy 20 is provided to supplement the secondary acoustic energy and provide more reliable LVL data. The further source of seismic energy is preferably disposed on the opposite side of the receiver array to the borehole, and may conveniently be a surface seismic source. The seismic energy emitted by the further seismic source is detected by the receivers of the DBS VSP receiver array, and can be processed in a conventional manner to provide information about the seismic properties of the LVL.

Where a LVL survey is carried out together with a conventional VSP seismic survey, the seismic receivers of the VSP surveying arrangement cannot be used for the LVL survey, since they are disposed within the earth's interior. Thus, where a LVL survey is carried out together with a conventional VSP seismic survey it is necessary to provide a separate receiver array for the LVL survey.

In contrast, in the present invention the receiver array used for a DBS VSP survey can also be used for an LVL survey according to the method of FIG. 5. This is true for both a linear radial land-based DBS VSP receiver array and for dual sensor, seabed DBS VSP receiver array. The present invention does not require any additional receivers in order to perform the LVL survey. Moreover, in an embodiment where a further source of seismic energy is provided to enhance the LVL survey, the existing array of seismic sensors can also be used for the measurements of the LVL layer using the further seismic source as well as for the measurements of the LVL using the re-radiated drill-bit noise as the energy source. Thus, the invention provides more accurate LVL measurements while not requiring any additional receivers.

The determination of the properties of the LVL according to the second aspect of the invention can be applied to monitoring the path of a borehole according to the first aspect of the invention. A monitoring method according to the first aspect of the invention uses DBS VSP data, and these data will be influenced by the LVL. By correcting the DBS VSP data for the effect of the LVL, for example by a method as described with reference to FIGS. 5 and 6, it is possible to further improve the updated geological model used to determine whether the drilling path is correct.

1. A method of monitoring the path of a borehole, the method comprising the steps of: drilling a borehole along a first path; acquiring drill bit seismic data; and determining from the acquired drill bit seismic data whether the first path is correct.

2. A method as claimed in claim 1 wherein the step of determining whether the first path is correct is performed while drilling the borehole.

3. A method as claimed in claim 1 or 2 and comprising the further step of: determining the first path of the borehole from a geological model of the earth's interior before drilling the borehole along the first path.

4. A method as claimed in claim 3 wherein the step of determining whether the first path of the borehole is correct comprises updating the geological model on the basis of the acquired drill bit seismic data.

5. A method as claimed in any preceding claim and comprising the further step of changing the drilling path of the borehole from the first path to a second path if it is determined from the acquired drill bit seismic data that the first path is not correct.

6. A method as claimed in any preceding claim wherein the step of acquiring drill bit seismic data is performed while drilling the borehole for a first time period; and wherein the step of determining whether the first path is correct is performed in a second time period after the first time period.

7. A method as claimed in claim 6 and comprising the step of drilling the borehole along the first path during the second time period.

8. A method of seismic surveying comprising the steps of:
disposing a drill string including a drill bit in a borehole; and
receiving seismic energy from the drill bit after transmission through the drill string and emission from the drill string at or near the earth's surface at a first seismic receiver disposed at or near the earth's surface.

9. A method as claimed in claim 8 and further comprising receiving seismic energy from the drill bit after transmission through the earth's interior at a second seismic receiver disposed at or near the earth's surface.

10. A method as claimed in claim 9 wherein the first seismic receiver is the second seismic receiver.

11. A method as claimed in claim 8, 9 or 10 and comprising the further step of receiving seismic energy from the drill bit after transmission through the drill string and emission from the drill string at or near the earth's surface at a third seismic receiver disposed at or near the earth's surface, the offset between the borehole and the third seismic receiver being small.

12. A method as claimed in any of claims 8 to 11, and comprising the further step of actuating a seismic source disposed at or near the earth's surface, and receiving seismic energy emitted by the seismic source at the first and/or second seismic receiver.

13. A method as claimed in claim 12 wherein the seismic source is on an opposite side of the first and/or second seismic receiver to the borehole.

14. A method as claimed in any of claims 8 to 13 and comprising the further step of processing seismic energy received at the first and/or second receiver to obtain information about a surface or near-surface layer of the earth.

15. A method of monitoring the path of a borehole as claimed in any of claim 1 to 7, and further comprising the step of acquiring seismic data using a method as defined in any of claim 8 to 14.

16. A method as claimed in claim 15 and comprising the further step of correcting the acquired drill bit seismic data for the effect of the surface or near-surface layer of the earth.
